(19) United States
(12) Patent Application Publication
(10) Pub. No.: US 2005/0273333 A1
(43) Pub. Date: Dec. 8, 2005

(54) Speaker verification for security systems with mixed mode machine-human authentication

(76) Inventors: Philippe Morin, Santa Barbara, CA (US); Rathinavelu Chengalvarayan, Naperville, IL (US)

Correspondence Address: HARNESS, DICKEY & PIERCE, P.L.C., P.O. BOX 828, BLOOMFIELD HILLS, MI, 48303, US

(21) Appl. No.: 10/859,489

(22) Filed: Jun. 2, 2004

(51) Int. Cl. G10L 17/00

(52) U.S. Cl. 704/247

(57) ABSTRACT

The central concept underlying the invention is to combine the human expertise supplied by an operator with speaker authentication technology installed on a machine. Accordingly, a speaker authentication system includes a speaker interface receiving a speech input from a speaker at a remote location. A speaker authentication module performs a comparison between the speech input and one or more speaker biometrics stored in memory. An operator interface communicates results of the comparison to a human operator authorized to determine identity of the speaker.

### FIELD OF THE INVENTION

The present invention generally relates to speaker verification systems and methods, and relates in particular to supplementation of human-based security systems with speaker verification technology.

### BACKGROUND OF THE INVENTION

Currently, large and profitable security/alarm companies provide access security to office buildings and/or homes based on information such as a person's name and PIN number. Typically, these companies employ humans to carry out part of the authentication procedure. For instance, an employee working after hours in a secure facility may be asked to call the security company's phone number and give his name anD PIN number to an operator. These human operators are capable of responding to unanticipated circumstances. Also, these operators can become familiar with voices and personalities of employees or other users over time, especially where employees frequently work late. Further, these human operators are capable of detecting nervousness. Thus, the human operator provides a backup authentication mechanism when PIN numbers are lost, stolen, or forgotten. However, this familiarity is temporarily lost when operator personnel are replaced or change shifts.

Studies have shown that today's speaker verification technology is better than human beings at detecting imposters by voice, especially if the human being is personally unfamiliar with the authorized person. However, extensive training is typically required to obtain a reliable voice biometric. Further, even where a reliable voice biometric is available, a person's voice can change in unanticipated ways due to a dramatic mood shift or physical ailment. Also, intermittent background noise at user locations can interfere with an authorization process, especially in a telephone implemented “call in” procedure with changing user locations not subject to control of background noise conditions. Accordingly, there are challenges to use of speaker verification technology by security/alarm companies.

What is needed is an advantageous way to combine capabilities of today's speaker verification technology with the capabilities of a human operator in a security/alarm company application. The present invention fulfills this need.

### SUMMARY OF THE INVENTION

A speaker authentication system includes a speaker interface receiving a speech input from a speaker at a remote location. A speaker authentication module performs a comparison between the speech input and one or more speaker biometrics stored in memory. An operator interface communicates results of the comparison to a human operator authorized to determine identity of the speaker.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating a speaker authentication system according to the present invention;

FIG. 2 is a block diagram illustrating structured contents of a speaker biometric datastore and functional features of a speaker verification module according to the present invention; and

FIG. 3 is a flow diagram illustrating a speaker authentication method according to the present invention.

### DETAILED DESCRIPTION OF THE PREFERRED EMBODIMENT

The following description of the preferred embodiment is merely exemplary in nature and is in no way intended to limit the invention, its application, or uses.

This invention is targeted at an authentication procedure for security systems which combines both human and machine expertise, where the machine expertise involves speaker verification technology. The current innovation does not propose to replace the human expertise represented by the security company's operators. Instead, the innovation supplements the operators' knowledge with additional knowledge, and makes them more productive. This increase in productivity is gained by supplying the output of a speaker verification module to each operator.

Human beings are very good at detecting signs of nervousness and using common sense to decide what to do if there is a possible intrusion—for instance, they may ask random follow-up questions or contact a trusted third party to verify the claimant's identity. Thus, the current invention does not require the security companies to change their mode of operation or throw away its advantages, but allows them to provide better security, possibly at lower cost, depending on how the invention is used.

The present invention aims at improving the level of security of the user authentication process offered by security/alarm companies by automatically supplying information on how well the claimant's voice print matches stored models, in addition to validating other credentials such as user name and PIN number. The output of the voice verification module can be displayed in a way that is clear even to operators unfamiliar with speech technology—for instance, a color coding scheme can be used to distinguish claimants who clearly match the stored models with those whose voice characteristics poorly match the stored models. If the match is good and there are no other suspicious circumstances (e.g., the claimant often works in this office at the current time of day) it may not be necessary for an operator to listen to the call at all. On the other hand, if the match is poor, the operator may ask follow-up questions. The answers to these questions are important in themselves (if they are wrong, the claimant is probably an imposter) and also a way of obtaining more speech data for assessing the claimant.

One aspect of the invention deals with the automatic enrollment of new users. The preferred enrollment strategy is to use unsupervised training for creating an initial voiceprint for a new user. Here, a voiceprint is created from the conversation that normally takes place between the caller and the security agent. The operator is aware (from information displayed on his/her monitor) that an initial voiceprint is being created. During the initial call, the user may need to answer a few more questions about him/herself such as his/her mother's maiden name, place of birth, and contact address of registered coworkers. The system may encourage the operator to converse with the new speaker until enough speech input has been gathered to create an initial voiceprint. A notification that the voiceprint has been created and/or successfully tested may be displayed to the operator. The voiceprint is automatically generated for every new user and can be adapted with data from subsequent calls for increased robustness. The initial enrollment process can alternatively be automated, with prompts designed to elicit answers of a type useful for enrollment and for creation of a voice biometric.

During future calls, the speech is measured against stored models in the background. The outcome of this assessment (e.g., a confidence level) may be displayed along with the claimed identity on the security agent's monitor. In the preferred embodiment, the displayed result would be in a color code for easy reading. For example, if the confidence measure is higher than the operating threshold, then the color code could be green indicating that the identified speaker is indeed the claimed user. On the other hand, if the confidence is low then the color code could be red, indicating a possible imposter for whom access can be denied. The color code can be orange in the case where the confidence level is borderline. In that case, the operator could request additional information to ensure positive identification. Here again, the claimant's answers can be assessed by the speaker verification system. The speaker specific acoustic models will be updated only if the color code is green; otherwise, the existing model remains the default to prevent corruption of voiceprint models.

In one embodiment of this invention, operators do not listen to calls with very high confidence—these calls are handled automatically. This option saves money and allows operators to focus on the more suspicious calls.

Another aspect of the invention integrates multiple levels of speaker verification into the security system. If the first level of speaker authentication fails, then a few more questions are asked. For example, the agent can ask about the mother's maiden name or user's birthplace depending upon the initial conversation. Here again the speaker verification system is activated to verify his/her answer. If the user obtains a high confidence (green light) then he/she can be granted access, otherwise the system goes into the third level of the verification process. In the third level, someone on a user-provided “trusted person” list (e.g., the boss of the claimed person) is contacted and asked to verify the claimant's identity.

An additional aspect of the invention is that the amount of information requested for a given user is minimized. For example, a user whose initial utterance of a name and a password is clearly verified is not asked any further questions. It is unnecessary for the user to pass all the levels of the verification process in this circumstance. In this way, the amount of effort required from the normal user is be minimized.

In a further aspect, the voice of the speaker can be compared at the time of enrollment and during subsequent operation to stored voice biometrics of potential interlopers, such as stored biometrics of departed company employees and/or current employees. These results can affect the success or failure of enrollment and/or authorization attempts. Speech recorded during failed enrollment and/or authorization attempts can be preserved for further analysis by authorities.

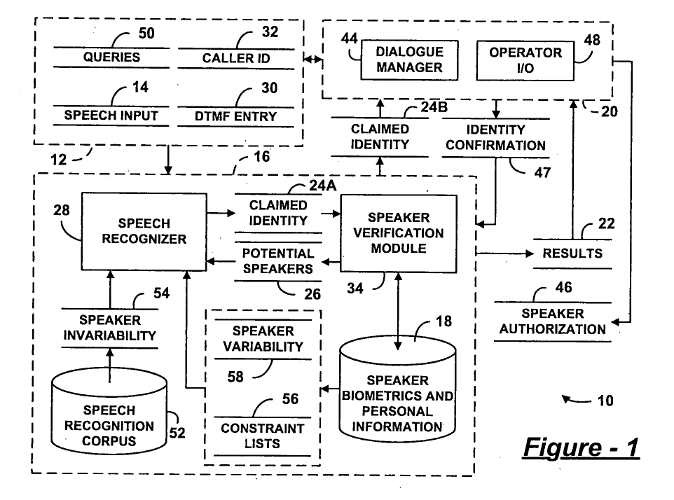

Referring to FIG. 1, a speaker authentication system 10 according to the present invention includes a speaker interface 12 receiving a speech input 14 from a speaker at a remote location. A speaker authentication module 16 performs a comparison between the speech input 14 and at least one speaker biometric of datastore 18. An operator interface 20 communicates results 22 of the comparison to a human operator authorized to determine identity of the speaker.

In some embodiments, the speaker interface 12 receives an identity claim 24A and 24B of the user. Accordingly, speaker authentication module. 16 is adapted to perform the comparison in a targeted manner. For example, one or more speech biometrics associated in datastore 18 with one or more potential speaker identities 26 matching the identity claim 24A and 24B is targeted for comparison. In some embodiments, speaker authentication module 16 includes a speech recognizer 28 that extracts the identity claim 24A and 24B from speech input 14. Identity claim 24A and 24B may alternatively or additionally be received in the form of a DTMF entry 30, such as a Personal Identification Number (PIN), from a remote user keypad. Yet further, caller ID information 32 may be employed as identity claim 24A and 24B, and/or to identify potential interlopers. Thus, there may be several identity claims which may or may not match one another, and several stored speech biometrics may be targeted for comparison.

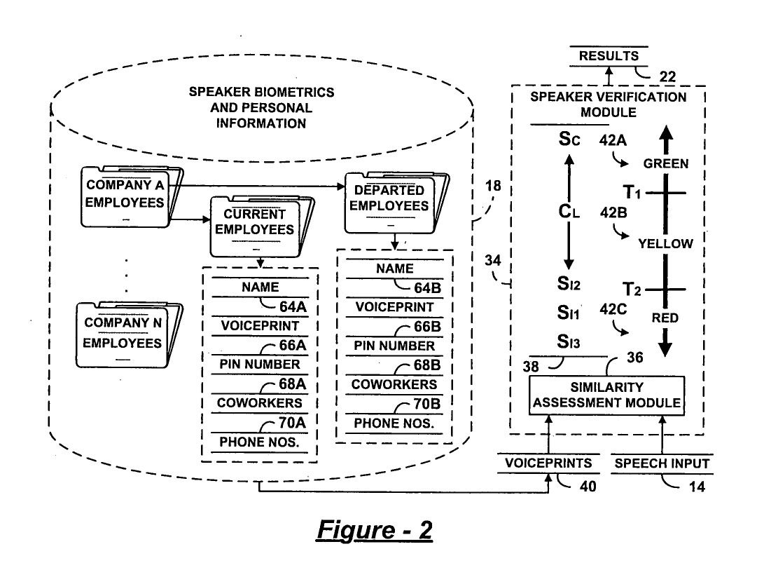

Turning now to FIG. 2, results 22 may be generated in a variety of ways. For example, speaker verification module 34 of speaker authentication module 16 (FIG. 1) may use a similarity assessment module 36 (FIG. 2) to obtain similarity scores 38 between voiceprints 40 of potential speakers from datastore 18 and speech input 14. These similarity scores 38 may be based on a comparison of one or more amounts of expected voice characteristics to one or more amounts of unexpected voice characteristics. Such similarity scores may additionally or alternatively be termed as confidence scores in the art. However, these types of scores are referred to herein as similarity scores in order to more clearly distinguish them from confidence scores obtained by comparing similarity scores associated with one or more claimed identities. For example, a similarity score of a claimed speaker identity S_{C} may be compared to the highest similarity score of potential interlopers S₁₁, S₁₂, and S₁₃ to obtain a confidence level C_{L} that the identity claim of the speaker is truthful. Alternatively, confidence level C_{L} may be based on a weighted average of comparisons between the score of the claimed identity and the scores of potential interlopers. Some classifications of interlopers may be weighted higher than others.

Verification module 34 may compare a score generated by the comparison, such as a similarity score or a confidence level, to two or more predetermined thresholds T₁ and T₂ selected to partition a range of results into three or more separate regions. These regions may include a favorable results region 42A, an unfavorable results region 42C, and a borderline region 42B, with the borderline region 42B situated between the favorable region 42A and the unfavorable region 42C. The regions may be associated with a color hierarchy, such as green for region 42A, yellow for region 42B, and red for region 42C. In such case, the results 22 may correspond to a color.

Returning to FIG. 1, speaker authentication module 16 may be adapted to automatically authorize the speaker if high confidence in the speaker authenticity exists instead of communicating results 22 of the comparison to the human operator authorized to determine identity of the speaker via the operator interface 20. In other words, if the results are “green” after an automated dialogue turn performed by dialogue manager 44 of operator interface 20, then the operator interface 20 may issue a speaker authorization 46 automatically without engaging an operator. However, if the results are “red” or “yellow”, then the operator interface may engage an operator via operator input/output 48, communicate the claimed identity 24B and results 22 to the operator, and turn over control of the speaker authorization process to the operator. The operator may then ask queries 50 that elicit additional personal information from the speaker.

During questioning of the speaker by the operator, speaker interface 12 may continuously receive additional speech input 14, and speaker authentication module 16 may continuously perform additional comparisons between the additional speech input 14 and one or more speaker biometrics stored in datastore 18. Accordingly, operator interface 20 continuously communicates results of the additional comparisons to the human operator. At any time, the human operator may specify a new claimed identity 24B, which is communicated to speaker authentication module 16. The operator may also specify the speaker identity with an identity confirmation 47 confirming the claimed identity assumed by authentication module 16. It is envisioned that the claimed identity assumed by the authentication module 16 may have been specified by the speaker or by the operator. A speaker authorization 46 issued by the operator may also be communicated to the speaker authentication module 16 as an identity confirmation 47. In response to such specifications of the speaker identity, speaker authentication module 16 is adapted to update a speaker biometric stored in datastore 18 in association with the speaker identity based on the speech input 14.

During an enrollment procedure, speaker authentication module 16 is adapted to create an initial speaker biometric based on speech input providing responses to enrollment queries for personal information. These queries may be generated automatically or administered by an operator. The responses provide the personal information, including the speaker identity, stored in datastore 18 in association with the speaker identity and the speaker biometric. Later, when the speaker calls in for authorization, speech recognizer 28 may use a speech recognition corpus 52 providing speaker invariability data 54 about words commonly used in personal information, such as known pass-phrases, numbers, and names of people, places, and pets. Non-speech data, such as a DTMF entry 30 of a PIN and/or caller ID information 32 may be used to generate an identity claim constraint list 56 and speaker variability data 58 for each potential speaker identity. Thus, multiple speech recognition attempts may occur specific to the potential identities. Accordingly, the ability of authentication module 16 to both recognize a speaker's speech and recognize a speaker may improve over time as the speaker uses the system and provides additional training data. During the progressive training process, an operator serves as backup to help identify the claimed identity and the speaker. Then, as the system begins to recognize the speaker reliably, the automated authorization process may reduce the load on the operators. However, the automated authorization may be automatically bypassed during increased alert conditions, or by companies or clients that do not wish to rely on automated authorization. Accordingly, some speakers may be automatically authorized, while others still result in a “green” result being communicated to an operator. Accordingly, an operator's authority to determine the speaker identity may be conditional or absolute, depending on the particular implementation of the present invention.

During the speech recognition process, it may be helpful for authentication module 16 to know what types of queries 50 are being asked by the operator so that proper constraints can be applied. For example, various personal information categories 60 (FIG. 2) may exist for each potential speaker 62, including name 64A and 64B, PIN number 66A and 66B, coworkers 68A and 68B, and phone numbers 70A and 70B of the speaker and/or coworkers. Accordingly, authentication module 16 (FIG. 1) may constrain recognition during questioning to stored personal information of the solicited category for each potential speaker. One way this functionality may be accomplished includes generating a random order of categorical queries and communicating them to the operator via operator interface 20. As a result, authentication module 16 automatically knows which category of information is being queried in each dialogue turn; dialogue turns can be detected automatically or specifically indicated by the operator. As a further result, authentication module 16 can help the operator avoid repeatedly querying for the same types of personal information in the same order; this randomization can assist in thwarting attempts at recorded authorization session playback by an interloper.

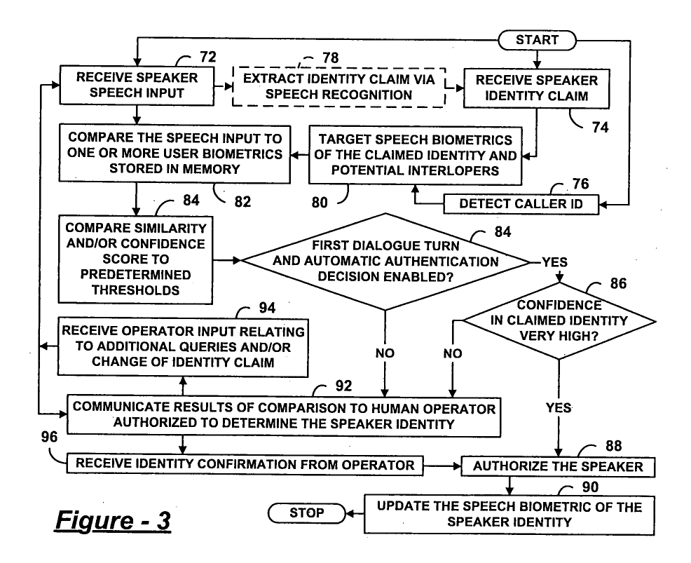

Turning now to FIG. 3, the method of the present invention begins with receipt of speaker speech input at step 72, receipt of a speaker identity claim at step 74, and optionally with automatic detection of caller ID at step 76. The speaker identity claim may be automatically extracted from the speech input at step 78, or received separately as a DTMF PIN or other data by another mode of communication. In some embodiments, a dialogue manager prompts the user for name and PIN number, and uses the PIN number as the identity claim to focus authentication attempts at step 80. Caller ID may alternatively or additionally be used to focus the authentication process at step 80, wherein speech biometrics of the claimed identity and potential interlopers are targeted for comparison. The comparisons occur at step 82, and resulting similarity scores and/or confidence scores are compared to one or more predetermined thresholds at step 84 to obtain a measure of confidence in the speaker identity.

If the first dialogue turn obtains a result of high confidence as at 84 and 86, and if the automatic authentication is enabled as at 84, then the speaker is automatically authorized at step 88. Then the speech biometric of the claimed speaker identity is updated with the speech input at step 90, and the method ends. However, if automatic authorization is not enabled at 84, or if the first dialogue turn does not result in high confidence at 86, then results of the comparison are communicated to a human operator authorized to determine the speaker identity at step 92. The operator then has the option to query additional personal information from the speaker to obtain additional speech input at step 72. The operator also has the option to specify which information is being queried and/or change the claimed identity at step 74. The operator further has the option to confirm that the claimed identity is correct at step 96 and to authorize the speaker at step 88, which results in update of the speech biometric at step 90. It is envisioned that the operator will continuously receive feedback at step 92 related to speaker authentication attempts continuously performed on new speech input continuously received at step 72. It is also envisioned that prior, failed authentication attempts may be rerun if the operator specifies a new claimed speaker identity at step 94. Accordingly, the automated speaker authentication and the operator authorization supplement one another to authorize speakers in a more reliable and facilitated manner.

The description of the invention is merely exemplary in nature and, thus, variations that do not depart from the gist of the invention are intended to be within the scope of the invention. This invention can be applied to business, home security, and any application that requires remote speaker authentication for secure access. Such variations are not to be regarded as a departure from the spirit and scope of the invention.

1. A speaker authentication system, comprising:
a speaker interface receiving a speech input from a speaker at a remote location;
a speaker authentication module performing a comparison between the speech input and at least one speaker biometric stored in memory; and
an operator interface communicating results of the comparison to a human operator authorized to determine identity of the speaker.

2. The system of claim 1, wherein said speaker interface receives an identity claim of the user, and said speaker authentication module is adapted to perform the comparison in a targeted manner, wherein a speech biometric associated with the identity claim is targeted for comparison.

3. The system of claim 1, further comprising a speech recognizer extracting the identity claim from the speech input.

4. The system of claim 1, wherein said speaker authentication module is adapted to compare a score generated by the comparison to at least two predetermined thresholds selected to partition a range of results into at least three separate regions including a favorable results region, an unfavorable results region, and a borderline region, wherein the borderline region is situated between the favorable region and the unfavorable region.

5. The system of claim 4, wherein the score is a similarity score resulting from comparison of the speech input to a single speaker biometric.

6. The system of claim 4, wherein the score is a confidence score reflecting at least one difference between two similarity scores resulting from comparison of the speech input to two speaker biometrics.

7. The system of claim 1, wherein said speaker authentication module is adapted to determine whether high confidence in the speaker authenticity exists by comparing a score generated by the comparison to a predetermined threshold, and wherein said operator interface is adapted to automatically authorize the speaker if high confidence in the speaker authenticity exists instead of communicating results of the comparison to the human operator authorized to determine identity of the speaker.

8. The system of claim 1, wherein said speaker interface is adapted to continuously receive additional speech input during questioning of the speaker by the operator, said speaker authentication module is adapted to continuously perform additional comparisons between the additional speech input and at least one speaker biometric stored in memory, and said operator interface is adapted to continuously communicate results of the additional comparisons to the human operator.

9. The system of claim 1, wherein said operator interface is adapted to receive operator specification of a speaker identity of the speaker, and said speaker authentication module is adapted to update a speaker biometric stored in memory in association with the speaker identity based on the speech input and in response to the operator specification.

10. The system of claim 1, wherein said speaker authentication module is adapted to create an initial speaker biometric during an enrollment procedure based on speech input providing responses to operator enrollment queries for personal information.

11. A speaker authentication method, comprising:
receiving a speech input from a speaker at a remote location;
performing a comparison between the speech input and at least one speaker biometric stored in memory; and
communicating results of the comparison to a human operator authorized to determine identity of the speaker.

12. The method of claim 11, further comprising:
receiving an identity claim of the user; and
performing the comparison in a targeted manner, wherein a speech biometric associated with the identity claim is targeted for comparison.

13. The method of claim 12, further comprising extracting the identity claim from the speech input via speech recognition.

14. The method of claim 11, further comprising comparing a score generated by the comparison to at least two predetermined thresholds selected to partition results into at least three separate regions including a favorable results region, an unfavorable results region, and a borderline region, wherein the borderline region is situated between the favorable region and the unfavorable region.

15. The method of claim 14, wherein the score is a similarity score resulting from comparison of the speech input to a single speaker biometric.

16. The method of claim 14, wherein the score is a confidence score reflecting at least one difference between two similarity scores resulting from comparison of the speech input to two speaker biometrics.

17. The method of claim 11, further comprising:
determining whether high confidence in the speaker authenticity exists by comparing a score generated by the comparison to a predetermined threshold;
automatically authorizing the speaker if high confidence in the speaker authenticity exists instead of communicating results of the comparison to the human operator authorized to determine identity of the speaker.

18. The method of claim 11, further comprising:
continuously receiving additional speech input during questioning of the speaker by the operator;
continuously performing additional comparisons between the additional speech input and at least one speaker biometric stored in memory; and
continuously communicating results of the additional comparisons to the human operator.

19. The method of claim 11, further comprising:
receiving operator specification of a speaker identity of the speaker; and
updating a speaker biometric stored in memory in association with the speaker identity based on the speech input and in response to the operator specification.

20. The method of claim 11, further comprising creating an initial speaker biometric during an enrollment procedure based on speech input providing responses to operator enrollment queries for personal information.

21. A speaker authentication system, comprising:
a speaker interface receiving at least one identity claim and at least one speech input from a speaker at a remote location;
a speaker authentication module performing a comparison between the speech input and at least one speaker biometric stored in memory, such that a speaker biometric associated in memory with a speaker identity related to the identity claim is targeted for comparison, wherein said speaker authentication module is adapted to compare a score generated by the comparison to at least one predetermined threshold selected to partition a range of results into at least two separate regions; and
an operator interface communicating the speaker identity and results of the comparison to a human operator authorized to determine identity of the speaker by asking additional questions eliciting additional speech input as personal speaker information from the speaker,
wherein said speaker interface, said speaker authentication module, and said operator interface are respectively adapted to continuously receive additional speech input during questioning of the speaker by the operator, continuously perform additional comparisons between the additional speech input and at least one speaker biometric stored in memory, and continuously communicate results of the additional comparisons to the human operator.
